(19) United States
(12) Patent Application Publication
(10) Pub. No.: US 2006/0116942 A1
(43) Pub. Date: Jun. 1, 2006

(54) Method and system for implementing option interests in real property

(76) Inventor: John Woyke, New Canaan, CT (US)

Correspondence Address: ALIX YALE & RISTAS LLP, 750 MAIN STREET, SUITE 1400, HARTFORD, CT, 06103, US

(21) Appl. No.: 11/002,333

(22) Filed: Dec. 1, 2004

(51) Int. Cl. G06Q 40/00

(52) U.S. Cl. 705/35

(57) ABSTRACT

The invention is a method and system of implementing option interests in real property. The owner of the property receives funds from an investor, which can be used to provide the property owner with income for living expenses or to use to lower the property owner's financing costs. In exchange for each payment, the property owner grants the investor a call option to purchase coupled with a put option to sell a fractional interest in the real property at some future date. The value of the investor's fractional share will increase along with the value of the property, allowing the investor to participate in rising property values. The owner does not pay interest on the monies received, leaving the cash flow for other purposes.

### FIELD OF THE INVENTION

The present invention relates generally to the financing of real property and more particularly to a method and system for implementing option interests in residential real estate.

### BACKGROUND OF THE INVENTION

Residential real estate has significantly appreciated in value in recent decades. In many cases, the cost of residential real estate has outstripped the ability of prospective buyers to provide the necessary down payment, which is typically on the order of 20% of the purchase price. In the current environment of low mortgage interest rates and high property values, it is typically the down payment and not the monthly mortgage payment that reduces the purchasing power of prospective purchasers. It may be possible to borrow more than 80% of the purchase price, but this may significantly increase the cost of financing and also reduce the cash flow available to the property owner for other continuing expenses. In some circumstances, such as large mortgages (so called “jumbo” mortgages), financing for more than 80% of the property value may not be available.

The appreciation of residential real estate has also raised interest in vehicles that would allow investors to participate in rising property values. Traditionally, investors participate in the residential real estate market through mortgage lending and mortgage backed securities. Mortgage lenders do not benefit directly from property appreciation, while they are exposed to property depreciation. Further, low interest rates and the fact that mortgages are homeowner and not lender callable, have kept investors from sharing in the appreciation of residential real estate.

There is a need for investment vehicles that will enhance the buying power of prospective homeowners by enhancing their ability to provide a down payment for the purchase of real property. Ideally, the arrangement would not require additional monthly payments by the property owner. To attract financing, the investment vehicle will allow an investor to participate in property appreciation.

### SUMMARY OF THE INVENTION

The invention is a method and system of implementing option interests in real property. A property owner receives funds from an investor, which can be used to provide the property owner with income for living expenses or to use to lower the property owner's financing costs. In exchange for each payment, the property owner grants the investor a call option to purchase coupled with a put option to sell a fractional interest in the real property at some future date. The value of the investor's fractional share will increase along with the value of the property, allowing the investor to participate in rising property values. The owner does not pay interest on the monies received, leaving the cash flow for other purposes.

Such an investment would serve as an inflation hedge, but would not bear the usual value fluctuation risks of similar investments (e.g., direct ownership of property, equities, collectibles) because it would have many of the attributes of debt. The investor stands little risk of losing the principal amount invested, because the investment is backed by the value of the property. Furthermore, the investor will have the right to exercise a put option that would require the property owner to buy back the investor's share of the property upon exercise of the call option. The options have a specific maturity date, but certain circumstances, such as default, placing of a lien on the property or sale of the property would trigger an earlier exercise date. The property owner would have the right to buy back the call and the put option from the investor, in whole or in part, at any time by paying the investor the net amount that the investor would receive had the investor exercised the put and call options (or a fraction thereof) at that time. The investment may guarantee a minimum level of fixed return and a minimum level of property value growth through the mechanisms of a Yield Spread Guarantee and a Minimum Rate Guarantee, respectively.

### BRIEF DESCRIPTION OF THE DRAWINGS

FIG. 1 is a flow chart illustrating the major steps of a computer implemented embodiment of the present method; and

FIG. 2 is a block diagram illustrating the basic functional elements of a computer system suitable for implementation of the present method.

### DETAILED DESCRIPTION OF THE PREFERRED EMBODIMENT

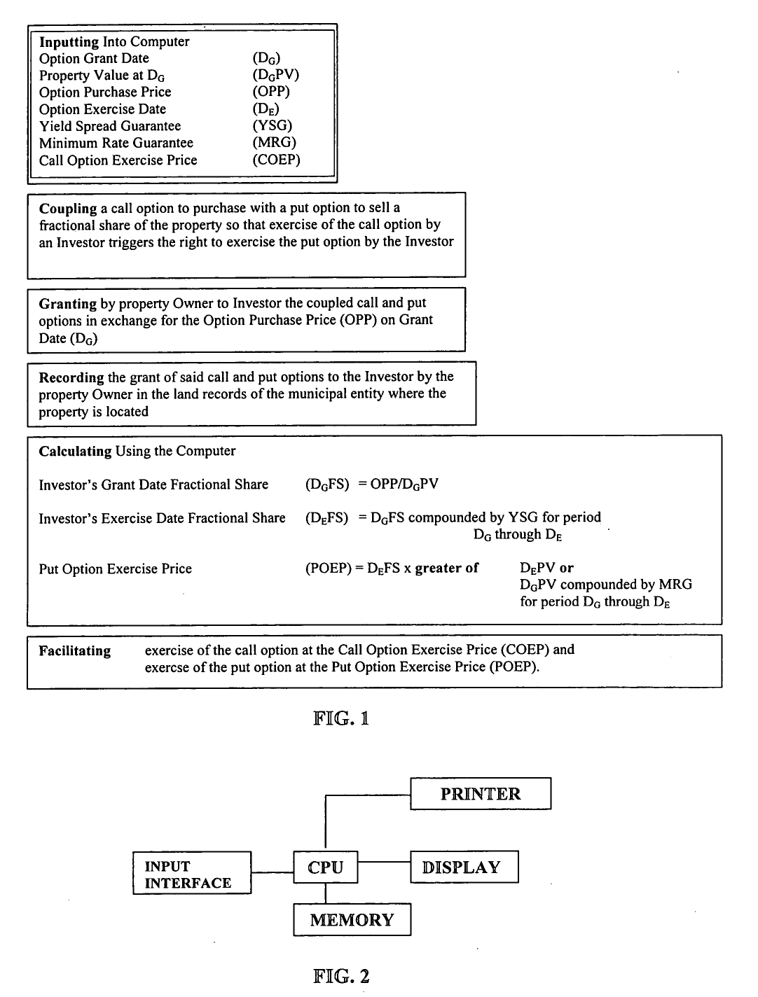

The method and system will now be described with reference to FIGS. 1 and 2. There will typically be three parties to a transaction according to the present method, a property owner, an investor and a third party who administers the investment vehicle. The property owner has a need for an amount of money, but may lack the cash flow to service additional borrowing. The investor can provide the needed funds, but requires some security and an assurance of a fair minimum return on his investment. The method facilitates an exchange between the property owner and the investor by providing an investment vehicle the meets both their requirements.

According to aspects of the present invention, the investment vehicle is in the form of options to purchase and sell a fractional share of the property at some future date granted by the property owner to the investor in exchange for the present payment of a sum of money. The terms of the option interests and the obligations of the investor and property owner are fixed by contract. The third party administrator will oversee the investment and the obligations of the parties by means of a computer system 20 as illustrated in FIG. 2. The computer system 20 is a typical system including a CPU, a display, an input interface such as a keyboard, memory for storage of data and algorithms and a printer for producing documents and reports. Variables that apply to the option interests are input into the computer and are used to produce a printed version of the option contract for the review and signature by the property owner and the investor. The contract or an abstract of the contract reflecting optional interests in the property granted by the property owner to the investor will typically be recorded in the land records of the municipality where the property is situated. This may be coupled with a lien on the property granted to secure the exercise of the options.

The property owner decides on the amount of funds needed, an annual level of income needed, or any other schedule of cash flows. These can be fixed or variable, but in the standard embodiment would be a single sum or a fixed annual amount. The property value is established by a recent sale or appraisal and is updated during the life of the investment vehicle. An option purchase price OPP is agreed upon that meets the property owner's funding needs. The option purchase price OPP is divided by the grant date property value D_{G}PV to determine the investor's fractional share of the property as of the grant date D_{G}FS. The option purchase price OPP may include an immediate payment portion IPP and a deferred payment portion DPP (OPP=IPP+DPP). The property owner receives the immediate payment portion IPP on the grant date. A call option exercise price COEP is fixed at the grant date and is at least equal to the deferred payment portion DPP of the option purchase price OPP. The deferred payment portion DPP may be zero.

The call option to purchase a fractional share of the property is coupled with a put option to sell the same fractional share so that exercise of the call option by the investor triggers his right to exercise the put option. In other words, exercise of the call option by the investor gives the investor the right to require the property owner to repurchase the investor's exercise date fractional share D_{E}FS of the property. The investor's exercise date fractional share D_{E}FS is a function of the grant date fractional share D_{G}FS and the time period between the option grant date D_{G} and the option exercise date D_{E}, as will be discussed in greater detail below.

The property owner would have the right to buy back the call and the put option from the investor, in whole or in part, at any time by paying the investor the net amount that the investor would receive had the investor exercised the put and call options (or a fraction thereof) at that time.

An aspect of the method relates to features that ensure a suitable minimum return to the investor. This can be accomplished by increasing the investor's fractional share of the property over time by means of a Yield Spread Guarantee YSG. In one embodiment of the invention, the yield spread guarantee YSG is a fixed percentage that is used to compound the investor's grant date fractional share D_{G}FS for the period between the option grant date D_{G} and the option exercise date D_{E}. In the basic embodiment, the yield spread guarantee YSG may be applied to the investor's grant date fractional share D_{G}FS in a compound manner to arrive at the investor's exercise date fractional share D_{E}FS. Thus, the investor's fractional share of the property increases over time.

Another means of assuring the investor an adequate minimum return is a minimum rate guarantee MRG to be applied to the grant date property value D_{G}PV. The grant date property value D_{G}PV is compounded by the minimum rate guarantee MRG for the period between the grant date D_{G} and the exercise date D_{E}. According to the invention, the resulting property value is compared to an appraised value of the property as of the exercise date D_{E}. The greater of the property value calculated by application of the minimum rate guarantee MRG or the actual appraised value of the property as of the exercise date D_{E} is used to calculate the value of the investor's exercise date fractional share D_{E}FS. The minimum rate guarantee MRG serves to assure the investor of a minimum rate of property appreciation during the life of the option.

Features of the options contract govern exercise of the call and put options to protect the interests of both the investor and the property owner. For example, exercise of the call option may be limited to particular circumstances, such as sale of the property, default by the property owner, or upon the expiration of a specified term of years, typically between 5 and 10 years. The date the call option is exercised is known as the exercise date D_{E}. Default by the property owner is defined in the option contract. Actions defined as default may include default on any underlying mortgage held by the property owner, an attempted refinancing of the property without the consent of the investor, the placement of a lien on the property, failure to adequately maintain the property, or other actions that could endanger the investor's option interest.

The terms of the put option give the investor the right to require that the property owner repurchase the investor's fractional share of the property in the event the call option is exercised. If the option contract includes a minimum rate guarantee, the property owner is required to repurchase the investor's exercise date fractional share D_{E}FS at the greater of the property's exercise date appraised value D_{E}PV or the grant date property value D_{G}PV compounded by the minimum rate guarantee MRG for the period between the grant date D_{G} and the exercise date D_{E}. The value of the investor's exercise date fractional share D_{E}FS according to these calculations may also be referred to as the put option exercise price POEP. The put option can be with recourse or without recourse. If it is without recourse it is to be satisfied solely from the property. There may be limits on exercise of the put option by the investor. For example, the put option might contain a provision that it can be exercised by the investor only if the investor arranges for mortgage financing, on commercially reasonable terms, for the property owner. (Thus, at the expiration of the option term the property owner can't be forced to repurchase the investor's interest for cash, but instead the fractional interest would be converted to a secondary mortgage on the property.)

Costs and fees for the program may be paid directly by the property owner. In one embodiment of the invention, the costs for the program are accounted for by increasing the investor's grant date fractional share D_{G}FS so that the net amount flowing to the property owner is not currently reduced. In this embodiment, all expenses and fees are satisfied from the property upon exercise of the options. Costs and fees may include initial closing costs, annual appraisal and administrative costs. In the standard embodiment these might be a fixed percentage of the initial appraised value of the property (i.e. initial “points”) and annual appraisal and administrative costs, which would be a smaller fixed percentage of the annual appraised value of the property (i.e., annual administrative fees). In certain cases, where the value of the property would depend on proper maintenance, the investor may insist on a third party overseeing that necessary maintenance is performed. This would result in an additional annual fee, the Annual Property Supervision Fee, which normally would be a small percentage of the annual appraised value of the property.

Capital improvements would be handled either by reducing the investor's exercise date fractional share D_{E}FS by the ratio of the appraised value of the property before the improvement divided by the appraised value after the improvement or by keeping the investor's exercise date fractional share D_{E}FS constant, but having the investor and property owner share the cost of the improvement in proportion to their respective fractional interests.

### Example of an Embodiment of the Invention

Assume a property owner wants to buy a home valued at $1,000,000. Assume he can obtain a mortgage for 80% of that price, but only has $100,000 to use as a down payment. The invention can provide him with the extra $100,000 need to purchase the property. Assume that the terms of an option according to the invention provide that the immediate payment portion IPP of the option purchase price OPP is 90%. Thus, to receive $100,000, the property owner would grant the investor a grant date fractional share D_{G}FS of 11.1111% of the property. The option purchase price OPP would be $111,111. The initial payment portion IPP would be $100,000. The deferred payment portion DPP would be $11,111.

The property owner does not have to pay interest for the $100,000 he has received. He would be obligated to pay an annual administrative fee to the third party administrator, but this would be small, such as 20 basis points times the appraised value of the property, and could be financed by increasing the investor's fractional share in the property. In this example we assume the property owner pays this fee in cash.

Assume that the option contract calls for a 2% yield spread guarantee YSG. Thus after one year the investor's fractional share would be (1.02) times 11.1111%, or 11.3333%, etc. After 5 years the investor's fractional share would be 12.26755%. Assume that the property has an appraised value of $1,500,000 after 5 years, and is either sold at its appraised value or the put option is exercised.

As of the exercise date D_{E} (five years from the grant date D_{G}), the investor's exercise date fractional share D_{E}FS (the investor's grant date fractional share D_{G}FS compounded by the yield spread guarantee YSG) would be 12.26755% of $1,500,000, or $184,013.3. The investor would have to pay $11,111, (the deferred payment portion DPP of the option purchase price OPP) to exercise the call option. In this example, the call option exercise price COEP is exactly equal to the deferred payment portion DPP of the option purchase price OPP. In this example, the investor would receive $172,902.3. This is an 11.57% return on the original investment of $111,111.

The property owner, on the other hand, would receive $1,327,098. After paying off an $800,000 mortgage (ignoring any amortization he might have had), he would be left with $527,098. The property owner benefits from low up front and continuing borrowing costs. Further, the invention increases the property owner's purchasing power, allowing him to benefit from appreciation on a more valuable property than might otherwise be possible.

Now let's suppose an alternative scenario. Assume the property does not appreciate at all, and is still worth $1,000,000 at the end of 5 years. Assume that the option contract provides for a minimum rate guarantee MRG of 4%. At the end of five years, therefore, the minimum rate guarantee MRG would be applied to ensure that the property has a minimum appraised value of $1,216,653. The investor would receive 12.26755% of that, or $149,253.50, but would pay $11,111 to exercise the option (the call option exercise price COEP). Thus the investor would get only $138,142.50. This is a 6.68% return to the investor. The Property owner would receive $861,857.50 or $61,857.5 after paying off his mortgage.

Glossary:

Property

The term Property means the real estate that would be subject to the invention's financing technique. Normally it would be a residential property occupied as a first or second home by the property owner.

Property Owner

The term property owner refers to the title holder of the property.

Investor

The term investor refers to the entity or person that is investing, through the invention, in an option to acquire a fractional interest in the property.

Contract

The term contract refers to an agreement between the property owner and the investor (or the investor's agent) that specifies the financial terms of the financing arrangement constituting the invention as well as the respective rights and obligations of the parties. The contract incorporates all of the terms of the call and put options, set forth how the exercise date property value D_{E}PV would be calculated, define events of default, set forth what constitutes capital improvements and all fees, charges and expenses. The contract might also set forth a schedule of cash flows or set forth the limits on cash flows that would be provided under the contract.

Cash Flow

The term cash flow refers to a payment made by the investor to the property owner (or to pay a fee or expense) as set forth in the contract.

Appraised Value of the Property

The appraised value of the property as of any date is an amount contractually agreed to by the parties as the value of the property. Normally it would be set by a qualified real estate appraiser from time to time, but the contract might provide that the value between appraisals would be equal to the last appraised value times an acceptable housing price factor, such as those applicable to the metropolitan statistical area in which the property is located published by the Office of Federal Housing Enterprise Oversight (OFHEO). Upon an arms-length sale of the property the appraised value of the property may be set at the sale price, less all closing costs. The exercise date property value D_{E}PV might be subject to a minimum rate guarantee MRG, which is a rate by which the property owner guarantees the property value will grow for purposes of the contract.

Yield Spread Guarantee YSG

This is a compound interest rate (e.g. 2% a year) that is applied to the investor's grant date fractional share D_{G}FS to calculate the investor's exercise date fractional share D_{E}FS. For example, if the investor's grant date fractional share D_{G}FS is 3 percent of the property and the yield spread guarantee YSG is 2%, the investor's fractional share after one year would be 3.06% (1.02 times 3%). At the end of two years it would be 3.1212% (3.06% times (1.02).

Investor's Grant Date Fractional Share D_{G}FS

The investor's grant date fractional share D_{G}FS is equal to the option purchase price OPP divided by the grant date property value D_{G}PV, e.g., the fair market value of the property as of the date the option is granted. For example, if the grant date property value D_{G}PV is $500,000 and the option purchase price OPP is $15,000, the investor's grant date fractional share D_{G}FS would be 3%.

Investor's Exercise Date Fractional Share D_{E}FS

The investor's exercise date fractional share D_{E}FS is the investor's grant date fractional share D_{G}FS increased by the minimum yield guarantee YSG as described above.

Option Purchase Price OPP

The option purchase price OPP is the gross amount of cash that the investor will pay for the option. It consists of an immediate payment portion IPP, which is paid at the time the option is granted, and a deferred payment portion DPP, which is paid when the option is exercised. This deferred payment portion DPP may also be referred to as the call option exercise price COEP.

Immediate Payment Portion IPP of the Option Purchase Price OPP

This is the fraction of the option purchase price OPP that is paid immediately. For example, the option may provide that 90% of the option purchase price OPP is payable immediately. If the total option purchase price OPP is $15,000, the immediate payment portion IPP would be $13,500. The immediate payment portion IPP of the option purchase price OPP could be 100%.

Deferred Payment Portion DPP of the Option Purchase Price OPP

This is the balance of the option purchase price OPP. For example, if the immediate payment portion IPP is 90%, the deferred payment portion DPP would be 10%. The deferred payment portion DPP of the option purchase price OPP could be zero.

Call Option Exercise Price COEP

This is the price the investor must pay in order to exercise the call option and obtain an undivided fractional interest in the property. The call option exercise price is at least equal to the deferred payment portion DPP of the option purchase price OPP, but may include an additional amount. If the deferred payment portion DPP of the option payment price OPP is zero, for example, there would normally be an additional amount payable so that the call option exercise price COEP would not be zero. The call option exercise price COEP may also increase with time, to reflect the time value of money.

Call Option

The call option is the portion of the contract between the property owner and the investor that grants the investor the right to buy a fractional share of the property for the call option exercise price COEP on the exercise date D_{E}.

Exercise Date D_{E}

The exercise date D_{E} for the call option is set forth in the contract between the property owner and the investor. The exercise date can be the earlier of a specified date, the date of sale of the property or any date set by the investor after an event of default (as defined in the contract). On the exercise date D_{E}, the investor has the right to tender the call option exercise price COEP and receive the exercise date fractional share D_{E}FS of the property.

Event of Default

An event of default is an event set forth in the contract between the investor and the property owner. In general, an event of default will occur whenever there is any action by the property owner that would trigger a risk of loss to the investor. An event of default would occur if the property owner defaults on any underlying financing, has a lien placed on the property without the consent of the investor, fails to properly maintain the property or engages in a similar activity.

Put Option

The put option is the portion of the contract between the investor and the property owner that allows or requires the property owner to repurchase the investor's exercise date fractional share D_{E}FS from the investor immediately after an exercise date in return for the put option exercise price POEP. If the investor exercises the put option, which would require the property owner to repurchase the investor's exercise date fractional share D_{E}FS for the put option exercise price POEP, the contract may impose conditions on such exercise, such as a requirement that the investor provide commercially reasonable financing to the property owner for the amount of the put option exercise price POEP. The property owner has the right, however, at any time prior to the exercise of the options, to repurchase them, in whole or in part, from the investor in return for the net amount the investor would have received has he immediately exercised them at such time.

Put Option Exercise Price POEP

The put option exercise price is based on the exercise date property value D_{E}PV. Normally it would equal the exercise date property value D_{E}PV times the investor's exercise date fractional share D_{E}FS, but the put option exercise price POEP could include a discount or premium from this amount.

Initial Closing Costs

The term initial closing costs refers to the fees and expenses to be paid at the date of execution of the contract. These may be financed from the first cash flow that would be paid at the date of execution of the contract.

Points

This would be an initial closing cost stated as a fee equal to a specified percentage of the grant date property value D_{G}PV.

Annual Administrative Fee

This would be an annual or other periodic fee set forth in the contract, which would typically be a specified percentage of the property value at the beginning of the year or other period. The annual administrative fee would be designed to cover the cost of necessary appraisals, recordkeeping and other ongoing expenses of the invention.

Annual Property Supervision Fee

This would be an annual or other periodic fee or other periodic fee set forth in the contract that would cover property management services. Typically this fee would apply if the property owner was unwilling or incapable of properly maintaining the property, or if the property owner simply desired the convenience of professional property management.

Capital Improvement

A capital improvement would be an improvement in the property that would increase its value. The term would be as defined in the contract. If there were to be a capital improvement, the cost could be shared equally by the property owner and the investor, in proportion to their respective fractional shares of the property as of the date of the capital improvement. Alternatively the property owner could pay the entire cost of the capital improvement and the investor's fractional share could be adjusted downward to reflect the value of the capital improvement.

Minimum Rate Guarantee MRG

This is a minimum rate by which the property value is contractually guaranteed to grow. Thus if there is a minimum rate guarantee MRG of 4%, and the grant date property value D_{G}PV is $1,000,000, then, after one year, the contract would provide that the minimum property value as of that date would be at least $1,040,000. The minimum rate guarantee MRG could have an effect solely for purposes of determining the put option exercise price POEP, but in the typical embodiment would apply for all purposes of the contract. For example, such as the determination of future option exercise prices (if additional funds were to be advanced to the property owner) and the determination of fees expressed in terms of a fraction of the property value at a given date.

While a preferred embodiment of the foregoing invention has been set forth for purposes of illustration, the foregoing description should not be deemed a limitation of the invention herein. Accordingly, various modifications, adaptations and alternatives may occur to one skilled in the art without departing from the spirit and the scope of the present invention.

1. A method for investor participation in ownership of real property having a property value which varies over time, said method comprising:
appraising the real property to arrive at an initial property value;
setting an option purchase price that an investor will pay said owner in exchange for a call option to purchase and a put option to sell a fractional ownership interest in said real property, said option purchase price being a function of said initial property value;
coupling said call option to said put option so that exercise of said call option by said investor triggers the right to exercise said put option by said investor;
granting said call and put options to said investor by said owner in exchange for at least a portion of said option purchase price at a grant date;
fixing, as of the grant date, a call option exercise price to be paid by said investor to exercise said call option;
adjusting said initial property value to determine an appraised value of said property as of said exercise date;
calculating:
a put option exercise price as a function of said appraised value and said fractional share as of said exercise date; and
facilitating exercise of said call and put options according to said call option exercise price and said put option exercise price, respectively.

2. The method of claim 1, comprising the step of:
allowing exercise of said call option by said investor only upon sale of the property, default by said owner or at the expiration of a specified period of years.

3. The method of claim 1, wherein said call option includes a yield spread guarantee to be applied to said fractional share at pre-determined time intervals and said method comprises:
calculating the investor's exercise date fractional share of said property by compounding said fractional share by said yield spread guarantee for each pre-determined time interval between said grant date and said exercise date.

4. The method of claim 1, comprising the step of:
requiring that said put option be satisfied solely from said property.

5. The method of claim 1, comprising the step of:
requiring said investor to arrange for mortgage financing for said owner in an amount sufficient to pay said put option exercise price.

6. The method of claim 1, wherein said put option includes a minimum rate of property value appreciation per pre-determined time interval and said step of adjusting comprises:
calculating said appraised value according to the greater of an actual property value appreciation as determined by an appraisal of said property or said minimum rate of property value appreciation.

7. The method of claim 1, comprising the step of:
recording the grant of said call and put options to said investor by said owner in a land records of a municipal entity where said property is located.

8. The method of claim 1, comprising the step of:
establishing a maturity date certain for exercise of said call option and allowing earlier exercise of said call option upon occurrence of enumerated events.

9. The method of claim 1, wherein said step of granting comprises:
granting a lien on said property to secure exercise of said call and put options.

10. The method of claim 1, comprising the step of:
permitting said owner to buy back said call and put options from said investor, in whole or in part, at a time elected by said owner by paying to said investor a net amount that said investor would receive had said investor exercised said put and call options at the time elected by said owner.

11. A computer implemented method for establishing and administering option interests in real property having a property value which fluctuates over time, said method comprising:
inputting data into the computer corresponding to:
a) an option purchase price payable by an investor to an owner of the real property in exchange for a grant to said investor of a call option to purchase, and a put option to sell, a fractional interest in the real property;
b) a grant date property value;
c) the length of time between said grant date and an exercise date of the options; and
d) an exercise date property value;
using the computer to calculate:
1) the investor's grant date fractional share of the property as a function of the option purchase price and said grant date property value;
2) the investor's exercise date fractional share of the property as a function of the investor's grant date fractional share and the length of time between said grant date and said exercise date; and
3) a put option exercise price as a function of said exercise date property value and the investor's exercise date fractional share of the property; and
coupling said call option to said put option so that exercise of said call option triggers the right to exercise said put option by said investor.

12. The method of claim 11, comprising:
requiring said owner to repurchase said investor's exercise date fractional share at said put option exercise price.

13. The method of claim 11, wherein calculating the investor's exercise date fractional share comprises:
compounding the investor's grant date fractional share by a yield spread guarantee for each pre-determined unit of time between said grant date and said exercise date; and
calculating said put option exercise price comprises:
multiplying said investor's exercise date fractional share by said exercise date property value.

14. The method of claim 11, wherein the step of calculating said put option exercise price comprises:
setting said exercise date property value at the greater of an actual property value appreciation as determined by an appraisal of said property at said exercise date or a calculated property value equal to the grant date property value compounded by a minimum rate guarantee per pre-determined unit of time for the period between said grant date and said exercise date.

15. The method of claim 11, comprising the steps of:
generating a contract document reflecting the rights and obligations of both said owner and said investor; and
recording said document in the land records of a municipal entity where said property is located.

16. The method of claim 11, wherein a call option exercise price payable by said investor for the exercise of said call option is fixed as of said grant date and said step of inputting includes:
inputting said call option exercise price.

17. The method of claim 11, wherein said step of inputting comprises inputting data into the computer corresponding to:
e) a maturity date certain for exercise of said call option.

18. The method of claim 1 1, comprising the steps of:
generating a contract document reflecting the rights and obligations of both said owner and said investor, said contract document including a lien on said property granted by said owner to said investor to secure exercise of said call and put options; and
recording said document in the land records of a municipal entity where said property is located.

19. The method of claim 1 1, comprising the step of:
permitting said owner to buy back said call and put options from said investor, in whole or in part, at a time elected by said owner by paying to said investor a net amount that said investor would receive had said investor exercised said put and call options at the time elected by said owner.
